(19) United States
(12) Patent Application Publication
(10) Pub. No.: US 2003/0006733 A1
(43) Pub. Date: Jan. 9, 2003

(54) Temporary power source for cellular phone

(76) Inventor: Sadaichi Abe, Tokyo (JP)

Correspondence Address: NIXON & VANDERHYE P.C., 8th Floor, 1100 North Glebe Rd., Arlington, VA, 22201-4714, US

(21) Appl. No.: 10/147,058

(22) Filed: May 17, 2002

(30) Foreign Application Priority Data
May 18, 2001 (JP) 2001-149024

(51) Int. Cl. H02J 7/00

(52) U.S. Cl. 320/114

(57) ABSTRACT

To achieve an object to provide a detachable temporary power source for cellular phone permitting a call for a very long period of time even for a cellular phone requiring a high power consumption, the present invention provides a temporary power source for cellular phone which makes it possible to make a call for a long period of time several times as long as that of a usual built-in power source, and can charge even built-in batteries of the cellular phone. The detachable temporary power source for cellular phone of the invention has a power source such as alkali dry battery, a diode, a regulator and a connector. Voltage supplied from the power source causes the regulator to supply a constant voltage, and has a power supply circuit preventing reverse flow of current from the built-in batteries of the cellular phone under the effect of the diode.

### BACKGROUND OF THE INVENTION

1. Field of the Invention

The present invention relates to a detachable temporary power source for cellular phone useful in a case where a cellular phone becomes unusable as a result of a voltage drop of a built-in power source, i.e., a decrease in the battery capacity, during use of the cellular phone.

2. Description of the Related Art

For a cellular phone, it is the conventional practice to use a lithium-ion battery as a built-in power source in many cases. The cellular phone is available for a certain period of time within the battery capacity. When voltage drops after use for a certain period of time, repeated use is possible by charging the built-in battery, thus standing use for a long period of time.

Since a cellular phone is often used when the user is away from home or the office, if voltage drop occurs in the lithium-ion battery during the user is away from home or the office, it is impossible to charge the battery, and it is necessary to replace it by a spare already charged battery.

However, the user must usually have such a spare battery, and in addition, it is necessary to always carry the spare battery, thus causing serious inconveniences, and in most cases, users do not actually carry such a spare battery.

To cope with such a case, therefore, there is conventionally available temporary power sources having a built-in alkali dry battery or manganese dry battery as temporary power sources having terminals capable of being connected to a cellular phone. The temporary power sources are commercially available at a low price in many stores. By purchasing a temporary power source, it is possible to use the cellular phone by supplying voltage from the temporary power source.

In this case, the battery of the presently available black-and-white liquid crystal cellular phone requires a voltage of from 3.5 to 4.5 V. A temporary power source uses three size AAA alkali dry batteries or manganese dry batteries, and a voltage of 4.5 V is used as a temporary power source.

A temporary power source using, for example, three size AAA alkali dry batteries is operable for only a very short period of call. For a cellular phone having a wide liquid crystal display screen or a color display cellular phone which are very popular at present, requiring a large power consumption, the temporary power source is usable only for a few minutes at the longest so that it cannot display the effect as a temporary power source at all.

For some manganese batteries, the cellular phone cannot even be turned on.

Because the conventional cellular phone had a black-and-white liquid crystal display section and limited imparted functions required only a very low power consumption, the power source could stand the use in the conventional models. However, now that the liquid crystal display section has become larger, with the mode has transferred to color display with increased added functions, there is an increase in power consumption of cellular phones, and the conventional temporary power source can no further cope with these present circumstances.

As a result, some of the conventional temporary power sources for cellular phone are not sufficiently of use for call when the built-in battery in a cellular phone suffers from voltage drop along with use and this results in impossibility to use. There has therefore been a demand for solving this problem.

Voltage of the conventional temporary power source is under restriction imposed by the reference voltage of the built-in battery of cellular phone, and because of the size restriction of the basing as a part of the temporary power source, it could not be free from the use of three size AAA dry batteries. Under these circumstances, there has been a demand for some effective solutions.

In addition, the reference voltage may vary with the model of cellular phone itself. A single temporary power source cannot therefore cope with all types of currently available cellular phones. This led to a demand for proposal of a temporary power source having a high general-purpose applicability.

The conventional temporary power source was to be used only when the built-in battery of a cellular phone suffered from voltage drop, causing hindrance of use. Upon occurrence of voltage drop of the temporary power source, the temporary power source was no further usable, and it was necessary to charge anew the built-in battery of the cellular phone itself.

Particularly, the AC adapter for charging had a supply voltage of from about 4.2 to 5.8: it had not a voltage sufficient to charge with the conventional temporary power source. On the contrary, current might reversely flow from the built-in battery to the temporary power source. It was thus impossible to expect a charging function.

In these respects also, it has been demanded to develop a temporary power source which can stand the use for a long period of time as a temporary power source when there occurs voltage drop of the built-in battery of the cellular phone, can charge the built-in battery of the cellular phone without the need to charge the built-in battery with a separate charger, does not cause an injury to the built-in battery of the cellular phone, and has a protecting function of the cellular phone.

Accordingly, it is an object of the present invention to provide a temporary power source for cellular phone, which can stand a long-time use easily and at a low cost, applicable to all currently available types of cellular phone as required, can charge the built-in battery of the cellular phone simultaneously with the use as a temporary power source, and has also a protective function of the cellular phone, thereby solving the aforementioned problems.

Another object of the invention is to provide, as required, a reusable temporary power source capable of being charged again as a temporary power source.

### SUMMARY OF THE INVENTION

To achieve these objects, the first aspect of the present invention provides a detachable temporary power source, comprising a power supply circuit having a power source using at least four size AA alkali dry batteries, which permits achievement of the aforementioned objects.

In the second aspect of the invention, the temporary power source may use size AAA alkali dry batteries in place of the size AA alkali dry batteries, and the objects of the invention can be achieved as well by this temporary power source for cellular phone.

Manganese dry batteries may be used in place of the alkali dry batteries as in the third aspect of the invention, and nickel-cadmium batteries or nickel-hydrogen batteries may also be used as in a fourth aspect of the invention.

This permits recharging.

Or, one or more lithium-ion batteries may be used as in the fifth aspect of the invention.

These power supply circuits, having a reverse current preventing circuit as in the sixth aspect of the invention permit prevention of reverse current from the cellular phone, leading to a higher safety.

The temporary power source may have a diode on the circuit as in the seventh aspect of the invention.

Having a constant voltage circuit as in the eighth aspect of the invention permits supply of a constant voltage to the cellular phone, thus improving safety of the cellular phone.

As in the ninth aspect of the invention, having a regulator on the circuit permits supply of a constant voltage and use for a long period of time.

It is needless to mention that, as in the tenth aspect of the invention, the temporary power source may have a resistance on the circuit to adjust voltage.

The eleventh aspect of the invention provides a detachable temporary power source having a power source, a diode, a regulator and a connector, wherein voltage supplied from the power source supplies a constant voltage through the regulator and there is a power supply circuit which prevents reverse flow of current from built-in batteries of the cellular phone by means of the diode.

The twelfth aspect of the invention provides a detachable temporary power source for cellular phone having a power source, a diode, a regulator, a resistance, one or more switches and a connector, wherein voltage supplied from the power source can supply a constant voltage by the diode and the regulator to the cellular phone via the connector, and there is a power supply circuit which can supply a lower supply voltage via the resistance by the connector to the cellular phone by changing over the switch; and it is possible to set at least two kinds of voltage to be supplied to the cellular phone by changing over the switch.

As described in the thirteenth aspect of the invention, the temporary power source may have resistances having different resistance values on the individual circuits changed over by the switch, and may have a configuration in which it is possible to set at least two kinds of voltage to be supplied to the cellular phone by changing over the switch, so as to provide different supply voltage values appropriately to different cellular phones having different values of allowable voltage.

Particularly, even in these cases, as described in the fourteenth aspect of the invention, a power source can be selected from various dry batteries including an alkali dry battery and a manganese dry battery, and a form of battery can be selected from very diverse variations including a size AA and a size AAA.

In the temporary power source for cellular phone of the invention, as described in the fifteenth aspect of the invention, it is possible to charge a built-in power source of a cellular phone, thus eliminating the necessity to recharge the built-in power source.

In the temporary power source for cellular phone having such a power supply circuit, as in the sixteenth aspect of the invention, in a case where four cylindrical dry batteries are used, two thereof are arranged in parallel, and each of the remaining dry batteries is positioned in two recesses produced between said two dry batteries; in this state, the batteries are housed in a casing; and the casing has a shape fitting this shape of arrangement.

This is also the case with a temporary power source for cellular phone described in the seventeenth aspect of the invention wherein, in a case where four cylindrical dry batteries are used, two thereof are arranged in parallel, and in a state in which projections of the two batteries thus arranged come into contact with the projections of the other two, a different member is present between these portions in contact, the batteries are housed in a casing, and the casing has a shape fitting this shape of arrangement.

The temporary power source of the invention, as described in the eighteenth aspect of the invention, may be such that, in a case where four cylindrical dry batteries are used, the four dry batteries are housed in a casing in a state in which the four batteries are arrange in parallel, and batteries located at the both ends are positioned with slight shifts in a certain direction; and the casing has an arcuate shape so as to fit the shape of arrangement.

The temporary power source of the invention, as described in the nineteenth aspect of the invention, may also be such that, in a case where four cylindrical dry batteries are used, the four dry batteries are housed in a casing in a state in which each two of the four batteries are arranged in parallel, and the two pairs are continuously connected in the longitudinal direction; and the casing has a shape fitting the shape of arrangement, or, as in the twentieth aspect of the invention, may be such that, in a case where four cylindrical dry batteries are used, the four dry batteries are housed in a casing in a state in which the four batteries are arranged in parallel; and the casing has a shape fitting the shape of arrangement, or, as in the twenty-first aspect of the invention, may be such that, in a case where four cylindrical dry batteries are used, the four dry batteries are housed in a casing in a state in which the four batteries are arranged in series, and the casing has a shape fitting the shape of arrangement.

By adopting any of the above-mentioned configurations, it is possible to supply voltage to a cellular phone for a very long period of time.

### BRIEF DESCRIPTION OF THE DRAWINGS

FIG. 1 illustrates an embodiment of the power supply circuit of the temporary power source for cellular phone of the present invention;

FIG. 2 illustrates the state of voltage drop of the temporary power source for cellular phone of the invention;

FIG. 3 illustrates another embodiment having a diode and a regulator of the power supply circuit of the temporary power source for cellular phone of the invention;

FIG. 4 illustrates another embodiment having a switch in the power supply circuit, capable of arbitrarily supplying a different voltage, of the temporary power source for cellular phone of the invention;

FIG. 5 illustrates an example of the casing in a case where four size AA dry batteries are house in the casing of the temporary power source for cellular phone of the invention;

FIG. 6 illustrates another example of the casing in a case where four size AA dry batteries are housed in the casing of the temporary power source for cellular phone of the invention;

FIG. 7 illustrates another example of the casing in a case where four size AA dry batteries are housed in the casing of the temporary power source for cellular phone of the invention;

FIG. 8 illustrates another example of the casing in a case where four size AA dry batteries are housed in the casing of the temporary power source for cellular phone of the invention; and

FIG. 9 illustrates another example of the casing in a case where four size AA dry batteries are used in the temporary power source for cellular phone having a switch.

### DESCRIPTION OF THE PREFERRED EMBODIMENTS

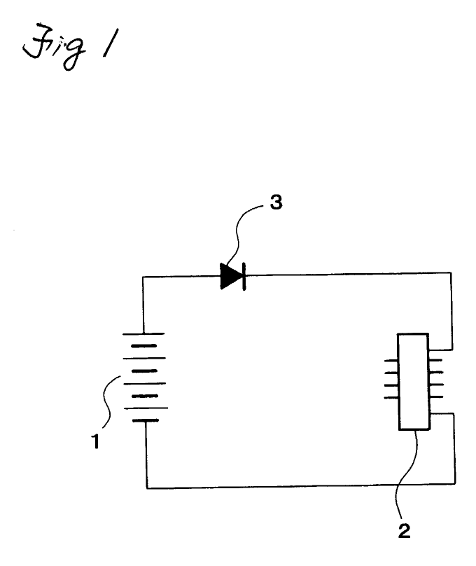

A basic embodiment of the present invention is illustrated in FIG. 1.

FIG. 1 shows an embodiment of the invention in which the power supply circuit comprises four size AA alkali dry batteries connected in series permitting the power supply circuit having a diode 3, supplying voltage of 6 V in total, and connected to the cellular phone via a connector 2.

It was the conventional practice to use three size AAA dry batteries connected in series as a temporary power source for cellular phone. This provides a total voltage of only 4.5 V, and suffers from a serious voltage drop caused by resistance of wiring upon actual use or the state of use. This cannot therefore be used for a cellular phone currently in use requiring a high powder consumption.

Particularly, a size AAA dry battery having a small electric capacity is not practically applicable to present and future cellular phones expected to require a larger power consumption.

In view of the built-in battery voltage of about 3.5 to 4.5 V for cellular phone, only three size AAA dry batteries have been used in all disposable temporary power sources for cellular phone to cope with this.

Because of the compact size of the casing, attention was given only to use of only three small-sized batteries, conventionally resulting in use of size AAA alkali dry batteries or manganese dry batteries.

The available rechargeable temporary power sources based on rectangular battery specifications. But these temporary power sources have only a small electric capacity, and the period before end of use caused by voltage drop is very short.

In contrast, the total voltage can be increased to 6 V by using four size AA dry batteries as a temporary power source for cellular phone shown in FIG. 1. Provision of a diode 3 permits prevention of reverse flow of current: reverse current flow from built-in batteries of the cellular phone can be prevented even upon voltage drop of the temporary power source.

Use of the diode 3 permits prevention of reverse current flow and perfect protection of the cellular phone upon supply of voltage to the cellular phone. The configuration in the present invention is not however limited to this, but the temporary power source of the invention may have a configuration without a diode.

Some models of cellular phone have a protecting circuit for supply voltage, and a temporary power source for cellular phone is not always required to have a diode.

Because a diode 3 permits supply of constant-voltage current, the temporary power source of the invention may ensure supply of constant-voltage current by use of a diode 3.

In these cases, the diode 3 may be replaced by, or may be used simultaneously with, a resistance, or may be used simultaneously with, or replaced by, a regulator.

Having a diode 3 is a basic requirement for an embodiment. The present invention is not however limited to this configuration, but may have a configuration without a diode, as required, or have a resistance or the like in its place.

It is desirable to have a reverse current preventing circuit for protecting the cellular phone as described above, but the invention is not limited to this, but may have a configuration without such a circuit.

In this case, an experiment was carried out until occurrence of voltage drop to such an extent as to make it impossible to use the cellular phone. This resulted in a call of about eight hours followed by an unusable state caused by voltage drop.

As compared with the possibility of call of only about three to four hours with the presently available batteries, this is the possibility of call for a very long period of time.

The result of the experiment carried out on a cellular phone having a liquid crystal display is shown in the following table.

TABLE 1

| | Power | |
|---|---|---|
| | source | Time of call |
| Temporary power source for cellular | ◯ | 470 min |
| phone using four size AA alkali | | |
| dry batteries of invention | | |
| A: three AAA alkali dry batteries | ◯ | 0 sec-19 min 50 sec |
| B: three AAA alkali dry batteries | ◯ | 31 min 30 sec |
| C: three AAA alkali dry batteries | ◯ | 43 min 28 sec |
| D: three AAA alkali dry batteries | ◯ | 7-8 min |
| E: three AAA manganese dry | X-◯ | 0 sec-1 min 11 sec |
| batteries | | |
| F: three AAA manganese dry | X-◯ | 0 sec-50 sec |
| batteries | | |
| G: three AAA manganese dry | X-◯ | 0 sec |
| batteries | | |
| H: three AAA manganese dry | X-◯ | 0 sec |
| batteries | | |
| I: rectangular battery used | ◯ | 30 min |
| Built-in battery (catalog value) | ◯ | 130-200 sec |

In Table 1, mark × in the column of power source means that even the power source could not be turned on; and mark ∘ means that the power source was turned on.

In the column of time of call, 0 second means that a call could not be connected.

Cases A to I represent commercially available temporary power source for cellular phone grouped in terms of model on the market: several units of the same model were subjected to the experiment.

Presence of dispersions in time of call within the same model is attributable to spontaneous discharge of batteries and state of use which are not uniform.

In case C using three size AAA alkali dry batteries, a time of call of 43 minutes 28 seconds was available for a cellular phone having a black-and-white liquid crystal screen, but a cellular phone having a color liquid crystal screen showed a time of call of 1 minute 30 seconds.

In contrast, the temporary power source for cellular phone of the invention permitted a call of about eight hours (about 470 minutes).

In the case of a temporary power source for cellular phone using three size AAA dry batteries, which is the most popular at present, the supply voltage cannot be maintained at a constant level in many cases in practical use, and violently fluctuates within a range of from about 4.7 to 3.8 V during a very short period of time. At a point in time when voltage drops as a result of this violent fluctuation, the power source is disconnected. Because of this fluctuation of supply voltage during, for example, several seconds or several tens of seconds, this type of temporary power source is not practically applicable at all.

In contrast, the temporary power source for cellular phone of the invention has a very flat supply voltage changing characteristic in which the supply voltage is constant and slowly decreases as a result of voltage drop. Disconnection of the power source therefore occurs as a result of voltage drop only when voltage drop is caused by a decrease in the battery capacity.

When applied in a cellular phone having a black-and-white liquid crystal screen, some of the conventional temporary power sources using three size AAA alkali dry batteries can provide a time of call which suggests usability to some extent. For cellular phones requiring a large power consumption such as those having a color liquid crystal screen now in popular use, these temporary power sources are almost unusable.

In contrast, the temporary power source for cellular phone of the invention can be used for a very long period, not only in a cellular phone having a black-and-white liquid crystal screen, but also in those having a color liquid crystal screen.

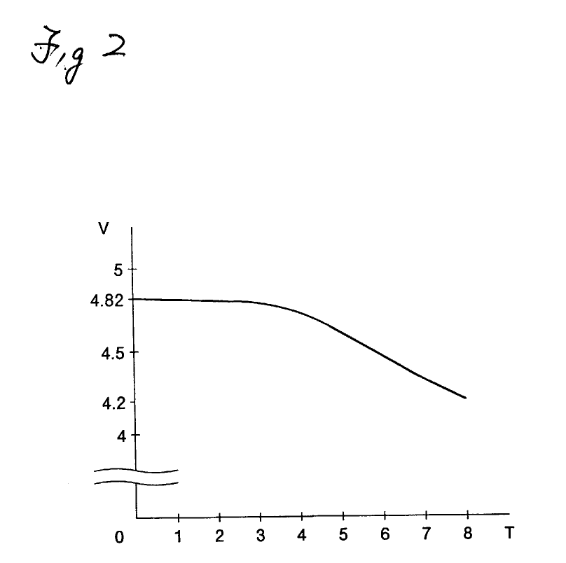

Voltage drop of the temporary power source for cellular phone of the invention is schematically illustrated in FIG. 2. Voltage is at 4.82 V at the start of a call, about 4.34 V upon the lapse of about seven hours, and 4.20 V upon the lapse of about eight hours, i.e., 470 minutes, thus becoming unusable.

The temporary power source for cellular phone of the invention can supply stable voltage for a very long period of time, and is usable for a long period of time.

While the basic configuration of the present invention comprises four size AA alkali dry batteries, but it may also comprise, for example, five or more size AA alkali dry batteries.

Size AAA dry batteries may be used in place of the size AA alkali dry batteries. Provided, however, in this case, that it is desirable to use at least five dry batteries, thus ensuring use for a long period of time.

Manganese dry batteries may also be used in place of the alkali dry batteries.

Nickel-cadmium batteries or nickel-hydrogen batteries may be used in place of the alkali dry batteries or the manganese dry batteries.

A nickel-cadmium or nickel-hydrogen battery provides a voltage of 1.2 V, and use of four batteries can provide a voltage of 4.8 V in total, suggesting sufficient applicability without using, for example, a diode.

More than five such batteries may be used, and use of five batteries provides a voltage of 6 V in total, so that this configuration is well usable.

The nickel-cadmium battery or nickel-hydrogen battery is rechargeable, and has therefore a higher practical applicability.

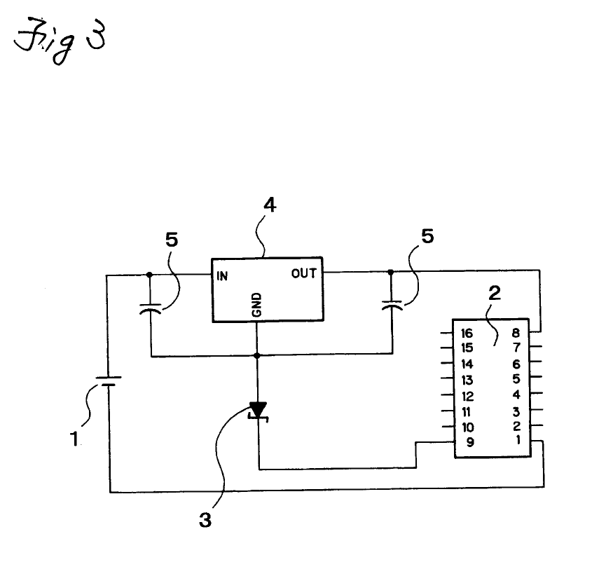

FIG. 3 illustrates another embodiment of the power supply circuit of the temporary power source for cellular phone of the invention.

The power supply circuit has a diode 3 for preventing reverse current, a regulator 4 for supply of constant voltage, and a connector 2 for connection to the cellular phone.

Voltage supplied from the power source 1 is converted into a constant voltage by the regulator 4, thus permitting supply of a constant current, and safety is increased by preventing reverse flow of current by means of the diode 3.

When the cellular phone itself has a voltage supply capacity, the temporary power source can sufficiently stand use even without a regulator 4 or a diode 3.

Voltage is supplied to the cellular phone by means of the connector 2.

For a case using this power supply circuit, four size AA alkali dry batteries were used as a power source. A call of 550 minutes was possible in the form of a continuous call. After the lapse of 550 minutes, voltage showed a slight increase, and then the power was disconnected.

At the start when the temporary power source for cellular phone was connected to the cellular phone, the built-in batteries of the cellular phone was in a vacant state, i.e., in a state in which voltage was so low as not to be usable for the cellular phone. The batteries were gradually charged by the connection from the temporary power source for cellular phone, and upon the lapse of the above-mentioned 550 minutes, the built-in batteries of the cellular phone were fully charged.

After the lapse of 550 minutes, the temporary power source for cellular phone was detached and measured again. Voltage was restored to a level of 4.26 V, and fitting it again to the cellular phone permitted another call of about 160 minutes.

To judge from all these findings, by connecting the temporary power source for cellular phone of the present invention in a vacant state of the built-in batteries of the cellular phone, a call of about 710 minutes in total by adding the time of call extended by recharging. After the lapse of this period of 710 minutes, another call of about 180 minutes which is an average available time of the usual built-in batteries is possible, because the built-in batteries are fully charged.

Therefore, a call of about 890 minutes is possible in total.

This period of time of call is really epoch-making. The temporary power source for cellular phone of the invention is useful, not only for emergency within Japan, but also for a case where during a foreign travel where the voltage is different from the domestic one, a charging adapter for the built-in batteries is unusable.

That is, the temporary power source for cellular phone of the invention makes it possible to make a continuous call for a period equivalent to, or even longer than, about five runs of recharging even for usual built-in batteries.

Even in a place such as seaside or mountain where it is impossible to recharge the built-in batteries, the temporary power source for cellular phone of the invention permits use of the cellular phone for a very long period of time.

For the case using the temporary power source for a cellular phone having a power supply circuit, changes in voltage of the temporary power source itself are shown in Table 2.

Four size AA alkali dry batteries were used as a power source 1 as described above. A 1A low-dropout three-terminal regulator was used as a regulator 4, with a 10 μF/10 V condenser and a diode 3.

TABLE 2

| Time (lapse) | Voltage | Time (lapse) | Voltage |
|---|---|---|---|
| Start | 4.54 V | 280 min | 4.30 V |
| 10 min | 4.53 V | 290 min | 4.30 V |
| 20 min | 4.49 V | 300 min | 4.30 V |
| 30 min | 4.47 V | 310 min | 4.29 V |
| 40 min | 4.45 V | 320 min | 4.29 V |
| 50 min | 4.44 V | 330 min | 4.28 V |
| 60 min | 4.42 V | 340 min | 4.28 V |
| 70 min | 4.40 V | 350 min | 4.28 V |
| 80 min | 4.39 V | 360 min | 4.28 V |
| 90 min | 4.38 V | 370 min | 4.27 V |
| 100 min | 4.38 V | 380 min | 4.27 V |
| 110 min | 4.36 V | 390 min | 4.26 V |
| 120 min | 4.36 V | 400 min | 4.26 V |
| 130 min | 4.35 V | 410 min | 4.26 V |
| 140 min | 4.35 V | 420 min | 4.26 V |
| 150 min | 4.35 V | 430 min | 4.26 V |
| 160 min | 4.35 V | 440 min | 4.26 V |
| 170 min | 4.35 V | 450 min | 4.25 V |
| 180 min | 4.35 V | 460 min | 4.25 V |
| 190 min | 4.34 V | 470 min | 4.25 V |
| 200 min | 4.34 V | 480 min | 4.22 V |
| 210 min | 4.34 V | 490 min | 4.21 V |
| 220 min | 4.34 V | 500 min | 4.18 V |
| 230 min | 4.35 V | 510 min | 4.20 V |
| 240 min | 4.34 V | 520 min | 4.20 V |
| 250 min | 4.34 V | 530 min | 4.18 V |
| 260 min | 4.34 V | 540 min | 4.18 V |
| 270 min | 4.31 V | 550 min | 4.23 V |

As shown in Table 2, voltage was 4.54 V at the start, and decreased gradually along with the lapse of time to 4.42 V upon the lapse of 60 minutes (an hour); 4.36 V upon the lapse of 120 minutes (two hours); 4.35 V upon the lapse of 180 minutes (three hours); 4.34 V upon the lapse of 240 minutes (four hours); 4.30 V upon the lapse of 300 minutes (five hours); 4.28 V upon the lapse of 360 minutes (six hours); 4.26 V upon the lapse of 420 minutes (seven hours); 4.22 V upon the lapse of 480 minutes (eight hours); 4.18 V upon the lapse of 540 minutes (nine hours); and then, after increasing upon the lapse of about 550 minutes, the power source of the cellular phone was disconnected.

While, in the meantime, voltage slightly increased for a short period of time, attributable to the ambient temperature and a change in condition, voltage gradually decreased as a whole.

At this point in time, the temporary power source for cellular phone of the invention was once detached, and voltage was measured again. Voltage had recovered the level of 4.26 V.

The temporary power source for cellular phone of the invention was therefore connected again to the cellular phone, turning on the power, and conducted a call. Call was possible.

Changes in voltage including this stage are shown in Table 3.

TABLE 3

| Time (lapse) | Voltage |
|---|---|
| Start | 4.54 V |
| 60 min | 4.42 V |
| 120 min | 4.38 V |
| 180 min | 4.35 V |
| 240 min | 4.34 V |
| 300 min | 4.30 V |
| 360 min | 4.28 V |
| 420 min | 4.26 V |
| 480 min | 4.22 V |
| 540 min | 4.18 V |
| 550 min | 4.23 V |

Power disconnected as a result of voltage drop

| | |
|---|---|
| After once detaching, | 4.26 V |
| Attached again | |
| 600 min (in total) | 4.25 V |
| 660 min (in total) | 4.20 V |
| 710 min (in total) | 4.18 V |

Power disconnected again as a result of voltage drop

Therefore, it was possible to conduct a continuous call for 550 minutes initially, and 160 minutes after re-attachment, i.e., for 710 minutes in total.

Upon the lapse of 710 minutes as described above, the built-in batteries of the cellular phones was in a fully charged state.

When using these built-in batteries, it is possible to make another call for about 180 minutes, and in total, a continuous call of about 890 minutes is possible.

In this case, no damage to the built-in batteries was observed.

While four size AA alkali dry batteries were used for this temporary power source for cellular phone, manganese batteries, nickel-cadmium batteries, nickel-hydrogen batteries or lithium-ion batteries may be used in place of these alkali dry batteries. Size AAA batteries may be used in place of the size AA batteries, and the number of dry batteries may be four or mote.

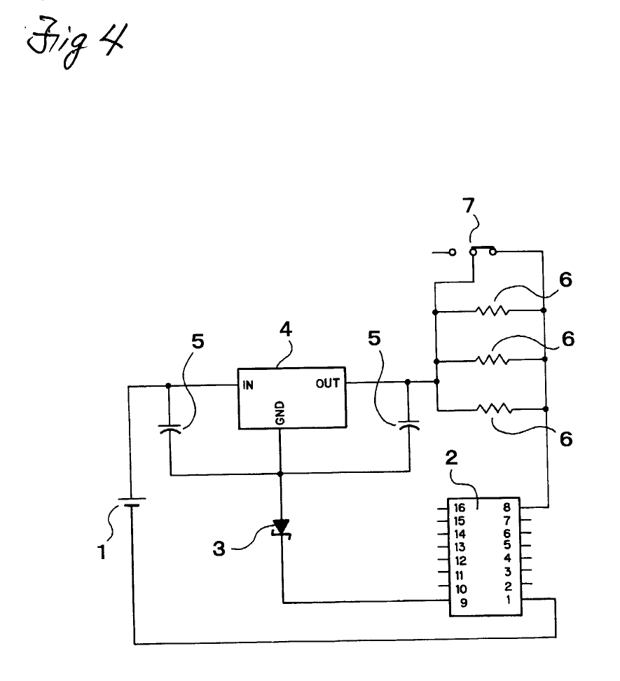

FIG. 4 illustrates another embodiment of the power supply circuit of the temporary power source for cellular phone of the invention.

The power supply circuit shown in FIG. 4 can supply different voltages through changeover by the switch 7, and can supply a voltage in response to requirement, for example, for different voltages between models of the cellular phone.

As in FIG. 3, this power supply circuit has a diode 3 for preventing reverse flow of current, a regulator 4 for constant voltage supply, and a connector 2 for connection to the cellular phone.

The current having passed through the regulator 4 can be switched over between current flowing into a resistance 6 and current flowing without a resistance by acting on the switch 7.

The resistance 6 shown in FIG. 4 has three resistances of 1 Ω/63 mW arranged in parallel, and as a result, it is possible to supply voltage of the current having passed through the regulator 4 as a lower voltage.

For example, the AC adapter for charging made by Sony Corporation has a supply voltage within a range of from 4.2 to 4.9 V, and many of the cellular phones made by NEC and other companies have AC adapters for charging of a supply voltage within a range of from about 5.3 to 5.9 V.

It is therefore possible to supply voltage on an appropriate level by acting on the switch 7.

Voltage supplied from the power source 1 can be converted into a constant voltage by the regulator 4, thus permitting supply of the constant voltage, and safety is improved by preventing reverse flow of current by means of the diode 3.

Voltage is supplied to the cellular phone through the connector 2.

Since the power supply circuit shown in FIG. 4 is only an example, the configuration may be such that the circuit has a switch 7 capable of changing over to multiple stages, comprising a circuit not having a resistance 6, and, when switched over to a plurality of other circuits, circuits having resistance 6 of difference resistance values.

The power supply circuit may have a plurality of switches 7, supplying different voltages.

Reference 6 having different resistance values may be provided on the individual circuits changed over via the switch 7, to permit causing them to supply different voltages by changing over the switch 7.

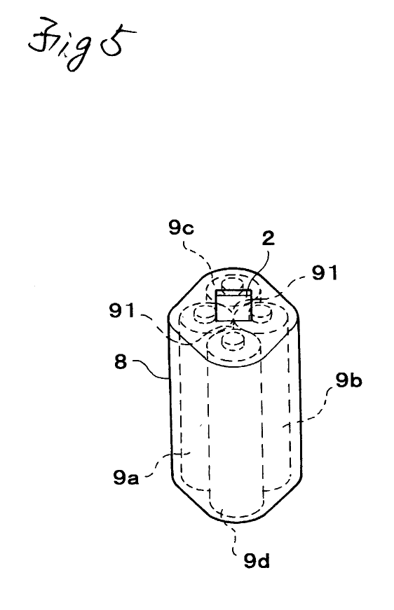

FIG. 5 illustrates a typical state of the casing 8 of the temporary power source for cellular phone of the invention: four cylindrical dry batteries 9a, 9b, 9c and 9d arranged so as to form substantially a diamond shape.

More specifically, two dry batteries 9a and 9b are arranged in parallel, and one of the dry batteries 9a and 9d is arranged each in two recesses 91 produced between the two arranged in parallel.

Because these batteries are arranged substantially into a diamond shape as viewed from above, use of a casing 8 having a shape fitting this diamond shape results in a temporary power source for cellular phone of a shape very easy to hold.

The temporary power source of the invention is connected to the cellular phone via the connector 2.

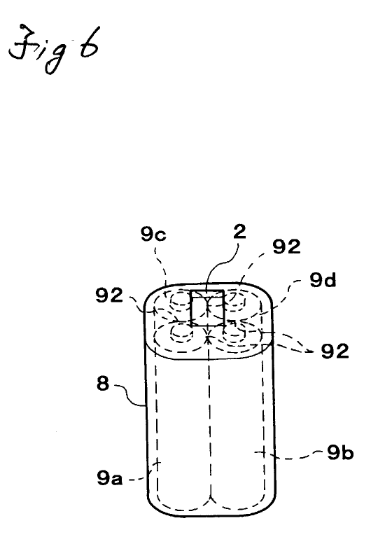

FIG. 6 illustrates a state in which four cylindrical dry batteries 9a, 9b, 9c and 9d are arranged so as to form substantially a rectangular shape as viewed from above and housed in a casing 8.

That is, two each of the four dry batteries are arranged in parallel and these two pairs of dry batteries are arranged into substantially a rectangular shape as viewed from above in a state in which projections 92 are in contact or another member is inserted between the portions in contact.

A configuration with a casing 8 having a shape fitting this arrangement of dry batteries provides a very easy-to-hold shape.

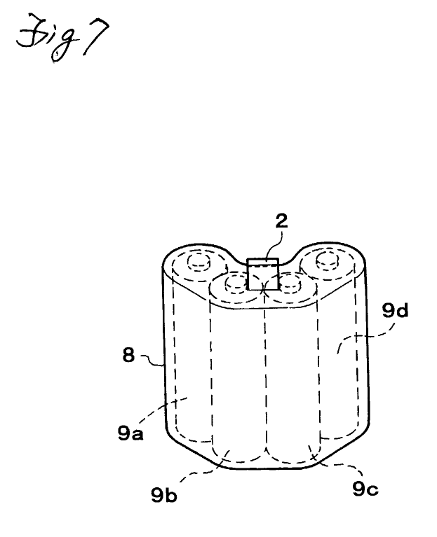

FIG. 7 illustrates a configuration in which four cylindrical dry batteries 9a, 9b, 9c and 9d are arranged and the dry batteries 9a and 9d positioned at the both ends are slightly shifted, with a casing 8 fitting this shape of arrangement.

The casing 8 itself can therefore be formed into substantially an arcuate shape, and as a result, it is possible to provide a casing 8 having a shape accurately fitting the curvature of the palm of the hand when holding the same.

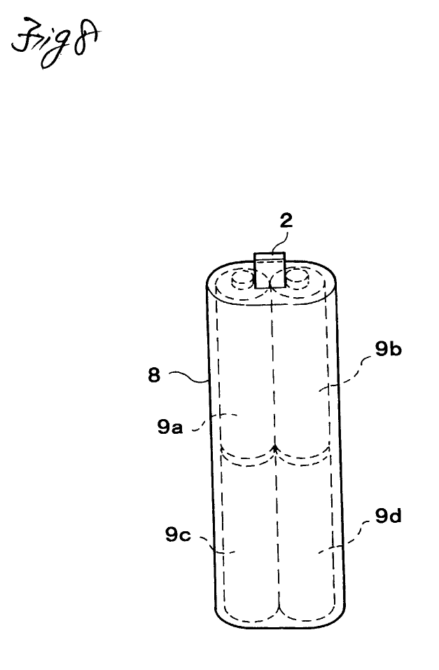

FIG. 8 illustrates a configuration in which, using four cylindrical dry batteries 9a, 9b, 9c and 9d, two of the batteries 9a and 9b are arranged in parallel, and the other two 9c and 9d are connected to below the former two, the four batteries being arranged in a casing 8 on the basis of this state.

This permits configuration of the casing 8 having a very easy-to-hold shape.

The four cylindrical dry batteries may be arranged in parallel in a longitudinal row.

Contrary to the conventional prerequisite of three dry batteries, even four batteries can be arranged in a compact casing providing a good appearance.

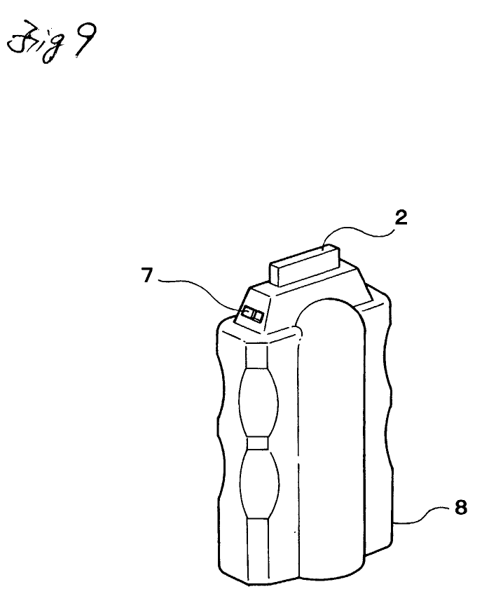

FIG. 9 illustrates another example of configuration in which, using four cylindrical dry batteries, two of these batteries are arranged in parallel, each one battery being arranged in each of two recesses produced between two parallel batteries, and the thus arranged dry batteries are housed in a casing 8 which has a shape fitting this shape of arrangement. This represents an embodiment of the temporary power source for cellular phone of the invention based on substantially a diamond shape having a switch 7 for switching over to a different voltage.

By acting on the switch 7, therefore, it is possible to set a different voltage optimum for a cellular phone to be connected.

According to the present invention, as described above in detail, there are available the following advantages:

1. The invention provides a first advantage of providing a temporary power source for cellular phone, permitting a call for a very long period of time even for a cellular phone requiring a large power consumption, by using four or more size AA dry batteries.

Particularly, as compared with most of the conventional temporary power sources for cellular phone permitting only a very short call almost denying practical applicability, the temporary power source for cellular phone of the invention makes it possible to make a very long call several times as long as usual built-in batteries.

More particularly, use of four size AA alkali dry batteries permits a continuous call for about 470 minutes, and addition of a regulator 4 on the circuit further permits a continuous call of about 710 minutes, thus standing a very long use. The temporary power source for cellular phone is well applicable in a place having no charger or during a foreign travel.

Even size AAA dry batteries similarly permit a long call.

2. By using a diode 3, there is available a second advantage of preventing reverse flow of current and of supplying a constant voltage.

It is therefore possible to prevent reverse flow of current from the built-in batteries of the cellular phone.

3. Use of a regulator 4 provides a third advantage of making it possible to supply a constant voltage.

It is therefore possible to safely and certainly accomplish supply of voltage optimum for the cellular phone.

4. The temporary power source for cellular phone of the invention permits a continuous call, in addition to the aforementioned first advantage, and charging of the built-in batteries of the cellular phone, thus providing a fourth advantage of spontaneously carrying out full charging of the built-in batteries.

This leads to another advantage of charging the built-in batteries simultaneously with use for a long period of time even at a place where no charger is available or during foreign travel.

5. Supply of different voltages becomes possible through switching of circuits by providing a switch 7 which makes it possible to change over the mode. This provides a fifth advantage of proposing a temporary power source for cellular phone having a high general-purpose feature.

6. There is available a sixth advantage of permitting very easy manufacture at a lower cost and providing a temporary power source for cellular phone having a wide range of applications.

7. A seventh advantage is the possibility to provide a temporary power source for cellular phone having an easy-to-hold casing 8.

8. The present invention provides an eighth advantage of permitting use of not only manganese batteries, but also nickel-cadmium batteries or nickel-hydrogen batteries in place of the alkali dry batteries, and when using nickel-cadmium or nickel-hydrogen batteries, permitting recharging, bringing about a temporary power source having a wide range of applications and a high practical applicability.

What is claimed is:

1. A detachable temporary power source for cellular phone, comprising a power supply circuit having a power source using at least four size AA alkali dry batteries.

2. A temporary power source for cellular phone according to claim 1, wherein said temporary power source uses size AAA alkali batteries in place of said size AA alkali dry batteries.

3. A temporary power source for cellular phone according to any one of claims 1 and 2, wherein said temporary power source uses manganese dry batteries in place of said alkali dry batteries.

4. A temporary power source for cellular phone according to any one of claims 1 and 2, wherein said temporary power source uses nickel-cadmium batteries or nickel-hydrogen batteries in place of said alkali batteries.

5. A detachable temporary power source for cellular phone, wherein said temporary power source uses one or more lithium-ion batteries.

6. A temporary power source for cellular phone according to any one of claims 1 to 5, wherein said temporary power source has a reverse current preventing circuit.

7. A temporary power source for cellular phone according to claim 6, wherein said temporary power source has a diode on the circuit.

8. A temporary power source for cellular phone according to any one of claims 1 to 7, wherein said temporary power source has a constant-voltage circuit.

9. A temporary power source for cellular phone according to claim 8, wherein said temporary power source has a regulator on the circuit.

10. A temporary power source for cellular phone according to any one of claims 1 to 9, wherein said temporary power source has a resistance on the circuit.

11. A detachable temporary power source for cellular phone having a power source, a diode, a regulator and a connector; wherein:
voltage supplied from the power source supplies a constant voltage through the regulator and there is a power supply circuit which prevents reverse flow of current from built-in batteries of the cellular phone by means of the diode.

12. A detachable temporary power source for cellular phone having a power source, a diode, a regulator, a resistance, one or more switches and a connector; wherein:
voltage supplied from the power source can supply a constant voltage by the diode and the regulator to the cellular phone via the connector, and there is a power supply circuit which can supply a lower supply voltage via the resistance by the connector to the cellular phone by changing over a switch; and
it is possible to set at least two kinds of voltage to be supplied to the cellular phone by changing over a switch.

13. A temporary power source for cellular phone according to claim 12, wherein:
said temporary power source has resistances having different resistance values on the individual circuits changed over by the switch; and
it is possible to set at least two kinds of voltage to be supplied to the cellular phone by changing over the switch.

14. A temporary power source for cellular phone according to any one of claims 11 to 13, wherein:
the power source is any one of those of claims 1 to 5.

15. A temporary power source for cellular phone according to any one of claims 1 to 14, wherein:
it is possible to charge a built-in power source of a cellular phone.

16. A temporary power source for cellular phone according to any one of claims 1 to 15, wherein:
in a case where four cylindrical dry batteries are used, two thereof are arranged in parallel, and each of the remaining dry batteries is positioned in two recesses produced between said two dry batteries; in this state, the batteries are housed in a casing; and the casing has a shape fitting this shape of arrangement.

17. A temporary power source for cellular phone according to any one of claims 1 to 15, wherein:
in a case where four cylindrical dry batteries are used, two thereof are arranged in parallel, and in a state in which projections of the two batteries thus arranged come into contact with the projections of the other two, a different member is present between these portions in contact, the batteries are housed in a casing; and the casing has a shape fitting this shape of arrangement.

18. A temporary power source for cellular phone according to any one of claims 1 to 15, wherein:
in a case where four cylindrical dry batteries are used, said four dry batteries are housed in a casing in a state in which the four batteries are arranged in parallel, and batteries located at the both ends are positioned with a slight shifts in a certain direction; and the casing has an arcuate shape so as to fit said shape of arrangement.

19. A temporary power source for cellular phone according to any one of claims 1 to 15, wherein:
in a case where four cylindrical dry batteries are used, said four dry batteries are housed in a casing in a state in which each two of said four batteries are arranged in parallel, and the two pairs are continuously connected in the longitudinal direction; and the casing has a shape fitting the shape of arrangement.

20. A temporary power source for cellular phone according to any one of claims 1 to 15, wherein:
in a case where four cylindrical dry batteries are used, said four dry batteries are housed in a casing in a state in which said four batteries are arranged in parallel; and the casing has a shape fitting the shape of arrangement.

21. A temporary power source for cellular phone according to any one of claims 1 to 15, wherein:
in a case where four cylindrical dry batteries are used, said four dry batteries are housed in a casing in a state in which said four batteries are arranged in series; and the casing has a shape fitting the shape of arrangement.
